(19) United States
(12) Patent Application Publication
(10) Pub. No.: US 2003/0112977 A1
(43) Pub. Date: Jun. 19, 2003

(54) Communicating data securely within a mobile communications network

(76) Inventors: Dipankar Ray, Plano, TX (US); Charles M. Feltner, Plano, TX (US); John Curtin, Richardson, TX (US)

Correspondence Address: John Han, Ericsson Inc., M/S EVW2-C-2, 6300 Legacy Drive, Plano, TX, 75024, US

(21) Appl. No.: 10/025,586

(22) Filed: Dec. 18, 2001

(51) Int. Cl. H04K 1/00

(52) U.S. Cl. 380/270

(57) ABSTRACT

Data is securely stored encrypted within a database server or portal within a public network. A wireless device first registers with an authentication center maintained separately from the database server to obtain a session key. The obtained session key is then used by the wireless device to request particular data from the database server. The database server, in response to said request, queries the authentication center to verify the authenticity of the wireless device. The authentication center verifies the received session key with the identified wireless device and provides the wireless device with a second group key. The authentication center further instructs the database server to comply with the data request and provide the wireless device with the encrypted data. The wireless device thereafter uses the received group key to decrypt the received data from the database server and is allowed access to the secured data.

### BACKGROUND OF THE INVENTION

1. Technical Field of the Invention

The present invention relates in general to the field of wireless data communications, and in particular, by way of example but not limitation, to storing and communicating data securely between a wireless device and a database server using wireless communication links.

2. Description of Related Art

With the advent of wireless communications and improvements made in the relevant technologies, more and more subscribers are relying on wireless devices to not only make voice call connections but also to access the Internet and to communicate other types of data. As an illustration, with the introduction of packet-switched wireless networks, mobile users are able to establish separate data communications links for exchanging data packets within a serving mobile telecommunications network. The General Packet Radio Service (GPRS) networks deployed as a 2.5 generation(G) wireless solution can, for example, provide communication speed between 50 Kbit/s to 144 Kbit/s. A higher 3G wireless solution, such as Wideband Call Division Multiple Access (WCDMA), also promises to deliver throughput between 384 Kbit/s to 2 Mbits. As a result, mobile subscribers are able to surf the web and communicate video or other multi-media messages using high-speed data access on their wireless devices.

With such an increase in data communication throughput in a wireless communication environment, more and more companies and information holders are also allowing their proprietary and confidential information to be accessible via wireless devices. In this regard, a wireless device has conventionally been used as a wireless modem for enabling a computing device to remotely log on to a corporate Local Area Network (LAN) to access proprietary business information. Computer users have also used a wireless device to remotely dial into any server or computer to remotely access and control any information that may be stored in that server. A user would therefore dial in using a wireless modem and log in using an appropriate user id and associated password to the server to retrieve and access any necessary information. In that regard, the serving mobile telecommunications network merely becomes a medium or transportation channel to connect the user to the home server or network.

However, in order to speed up the access time and to ensure that the data can be made available within a mobile service area, computer users have also placed their desired information out on a third party domain or server. As an example, MSN Passport is such a service allowing users to store and retrieve personal information within the MSN server. The MSN server is placed out on the world-wide web (WWW) and an authorized user having access to the Internet may freely access and retrieve any information that may be stored within this public server. Using a wireless application protocol (WAP), a mobile user is also able to retrieve her proprietary or personal information from the MSN Passport portal over a wireless communication network. There are also a number of other web-portals and services enabling users to create, store and retrieve information within a particular server via the Internet.

In a similar manner, more and more companies are posting their proprietary and business information on a public server or portal and allowing its employees to gain access to the desired information via wireless connection. Accordingly, regardless of a user's current location, the user may log on to the Internet and access her proprietary and/or personal information without having to dial in or log in remotely to her computer server.

However, the security of a wireless communications system becomes a crucial factor in determining the quality of the system and the integrity of the data that are being stored in those servers. Although all information communicated between a wireless device and a particular server may be encrypted and protected, the wireless device itself can be misplaced or stolen to allow unauthorized access. Furthermore, an interception or debugging of a communication link can also allow further unauthorized access to such information. A third party vendor, such as MSN Passport, can also inadvertently provide unauthorized access to the information stored in its own database server. Lastly, most users do not wish to trust or rely on a third party vendor to protect and maintain their proprietary information. In this regard, other than providing a transparent communication link to a particular portal, the existing wireless communications network does not provide any additional security measures or mechanism for securely communicating data with a wireless device.

There is accordingly a need for a method and apparatus to more securely store and communicate data between a wireless device and a data server using a mobile communications network.

### SUMMARY OF THE INVENTION

The present invention provides a method and apparatus for securely storing and communicating data within a wireless communications network. The present invention is directed to storing particular information securely within a publicly available database server by encrypting the data using a particular data access key. A separate authentication center associated with a serving mobile communications network maintains such data access key for that particular information and determines whether a particular wireless device has authority to access such information.

In certain embodiment(s), a wireless device or user registers with a mobile communications network by authenticating itself with the mobile authentication center. In response to an affirmative registration, a session key (first key) is generated by the authentication center and provided to the wireless device. The wireless device then uses this session key to identify itself whenever it wishes to access particular information stored within the centralized database server. In order to access said information, the wireless device therefore sends a request signal to the database server using its assigned session key and further identifying a particular database record to be accessed. The database server, in response to said request, sends an authentication request to the mobile authentication center using the received session key. The mobile authentication center verifies the authenticity of the provided session key and further determines whether the identified wireless device has appropriate authority to access said particular information. In response to an affirmative determination, the mobile authentication center provides the wireless device with a group key (second key). The mobile authentication center further instructs the database server to provide the wireless device with the requested information. The database server, in response to said response, provides the wireless device with the information associated with the identified database record. The wireless device decrypts the received information using the group key provided by the authentication center. As a result, the encryption key and the encrypted data are securely provided to the wireless device via using two different signaling paths.

In one embodiment, said second key is generated from said session key (first key) and said data access key.

In another embodiment, said mobile authentication center assigns a valid time period for said generated session key for said wireless device.

In yet another embodiment, said mobile authentication center generates a database key (third key) and provides it to the database server for further encrypting the requested information to be transmitted to the wireless device.

In yet another embodiment, the database server requests and obtains authorization from said authentication server for allowing the wireless device to store and update information associated with a particular database record within said database server.

### BRIEF DESCRIPTION OF THE DRAWINGS

A more complete understanding of the method and apparatus of the present invention may be had by reference to the following detailed description when taken in conjunction with the accompanying drawings wherein:

FIG. 1 is a block diagram of a public land mobile network communicating with a database server and a computer network;

FIG. 2 is a block diagram of an authentication center associated within a mobile network communicating with a database server in accordance with the teachings of the present invention.

FIG. 3 is a block diagram of a wireless device registering and performing authentication with the mobile authentication center;

FIG. 4 is a block diagram of a wireless device requesting and gaining access to securely stored data within the database server;

FIG. 5 is a signal sequence diagram illustrating the signals transmitted to request and to gain access to securely stored data within the database server;

FIG. 6 is a block diagram illustrating the data structure for storing a data access key for particular data record within the authentication center;

FIG. 7 is a block diagram illustrating the data structure for storing a particular user with an associated authentication center within the database server; and

FIG. 8 is a block diagram of a wireless device storing data securely within the database server.

### DETAILED DESCRIPTION OF THE DRAWINGS

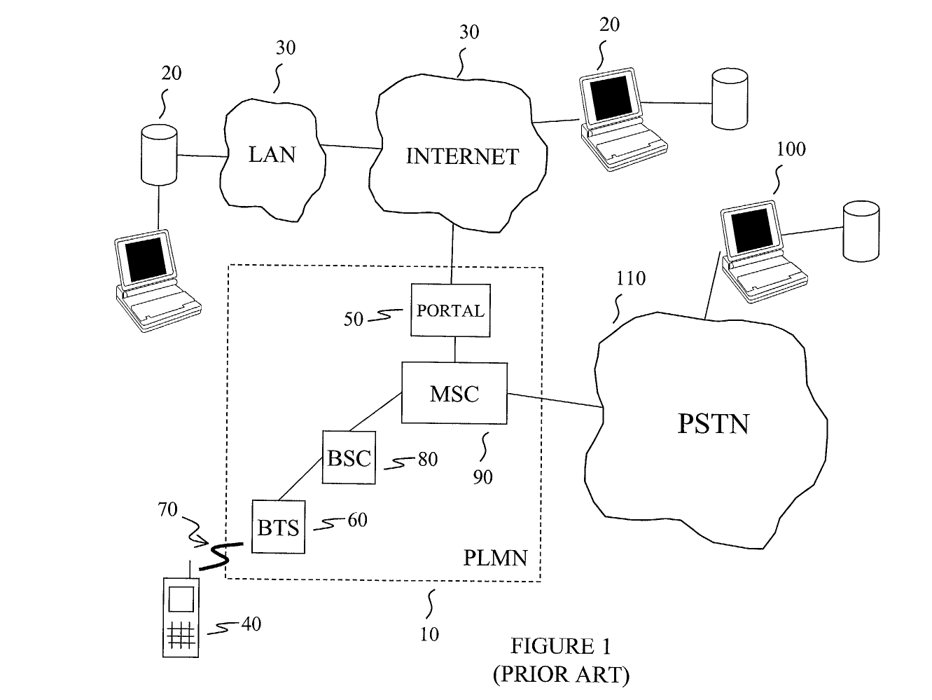

FIG. 1 is a block diagram of a public land mobile network (PLMN) 10 communicating with a database server 20 and a computer network 30.

Within a conventional manner, a mobile station or wireless device 40 establishes a circuit switch connection or wireless application protocol (WAP) connection with a particular portal 50. Accordingly, a serving base station transceiver (BTS) 60 providing radio service for a service area establishes two way radio channel connections 70 with a wireless device 40 located therein. A call connection is then forwarded over to an associated base station controller (BSC) 80, which is in turn, connected over to a mobile switching center (MSC) 90. The MSC then switches this call connection over to a designated portal 50. Through this portal, such as Phone.com, the wireless device 40 is able to surf the web 30 and be connected to a specific local area network (LAN) and associated computer servers and databases.

Alternatively, the wireless device 40 establishes a voice connection with a particular computer network by dialing a specific modem number associated thereto. Accordingly, the wireless device 40 remotely dials into a particular computer server 100 by establishing a circuit connection through a serving public switched telephone network (PSTN) 110. Using a pair of modems, the wireless device is then able to retrieve and have access to the data stored within the computer network 100.

However, in a conventional manner as described above, other than existing security measures provided by the computer networks 30, the serving mobile network 10 does not provide any additional or separate security measures to wireless devices and users.

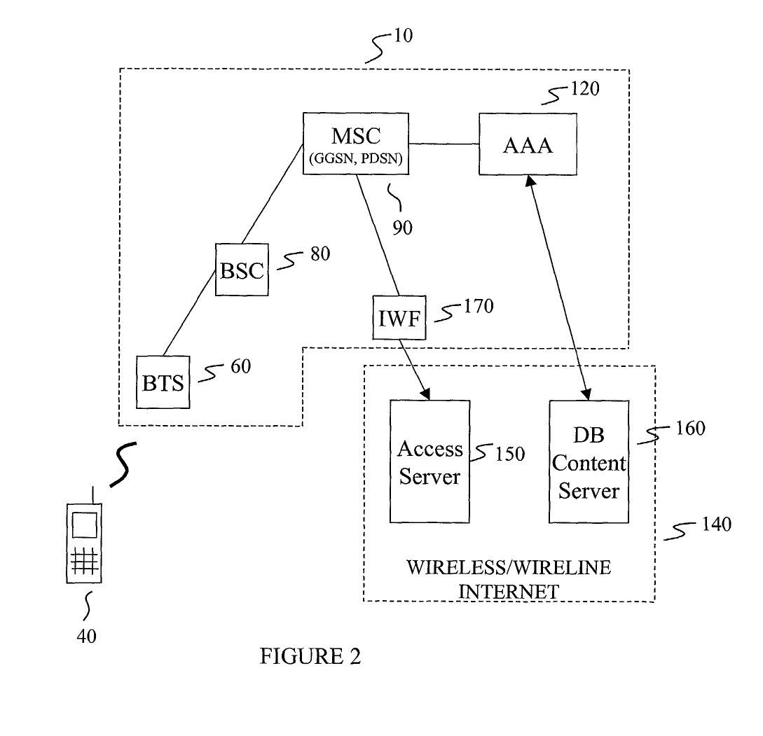

Reference is now made to FIG. 2 showing a block diagram illustrating a wireless device 40 communicating with a serving mobile network 10 and accessing data stored securely within a database server 160. An Authentication, Authorization and Accounting (AAA) center 120, also referred hereinafter as the authentication center, is associated with a serving mobile network 10 in accordance with the teachings of the present invention. The AA center 120 is also communicably coupled to the database server 160. The database server 160 also may be coupled to an access server 150 for acting as a gateway for receiving and transmitting signals. The access server may also be capable of communicating with a serving MSC 90 or any other telecommunications node via an interworking function (IWF) 170. For exemplary reasons, the access server 150 and the database server 160 are shown as two separate entities or nodes within a wireless/wireline Internet 140 environment. However, the two functions can be co-located or performed by a single node or platform. Furthermore, a mobile switching center (MSC) and associated communications entities illustrated in FIG. 2 herein are a representative of but one particular embodiment. Other communications nodes performing similar functions, such as Gateway GPRS Support Node (GGSN) for providing packet switching capability within an GSM system or Packet Data Support Node (PSDN) for providing similar capability within a CDMA system may be used with no change in the principles being discussed.

In accordance with the teachings of the present invention, the database server 160, also referred to as the DB content server, stores particular data encrypted using a user specified key (data access key). The data access key itself is unknown to the database server and stored separately within the authentication center 120. As a result, any access to the database server and its contents is useless without also having access to the relevant data access key stored separately in the authentication center associated with that user's home mobile network.

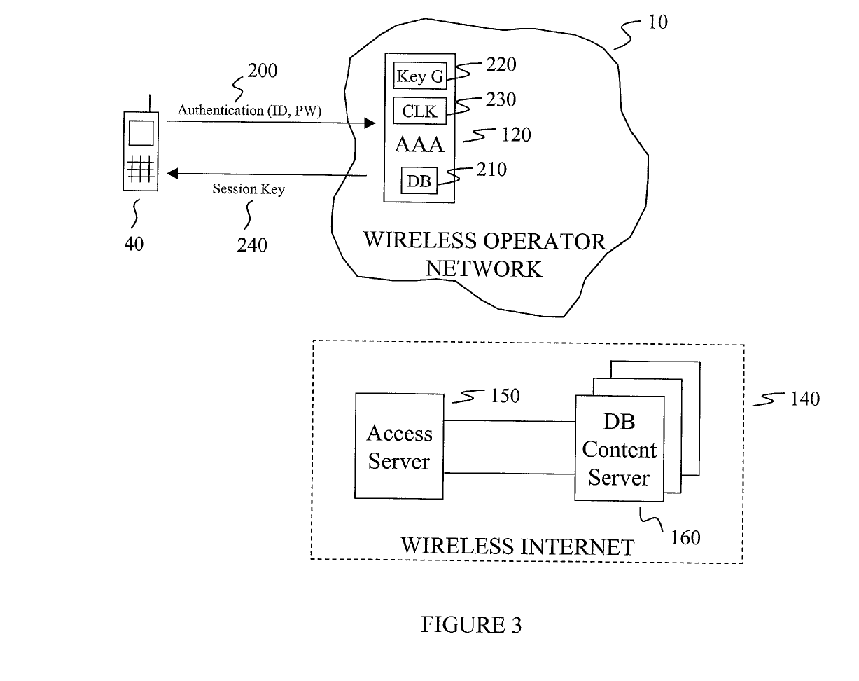

Reference is now made to FIG. 3 illustrating a wireless device 40 registering and performing authentication with it's authentication center 120 in accordance with the teachings of the present invention. The wireless device 40, such as a mobile terminal or wireless Personal Directory Assistant (PDA), performs a registration and authentication process with a serving mobile network 10 by transmitting a request signal 200 to an associated authentication center 120. Such a request signal may further include subscriber or user identification data as well as an associated password. The step of transmitting such a request signal 200 could be performed in a number of different ways, using for example, Short Message System (SMS) or other unstructured data messages, WAP signals, or other types of data packet communications. The authentication center (AAA) 120 then determines whether the requesting wireless device or associated user is allowed to have access to a database server by referencing an internal database record 210. In response to an affirmative determination, the authentication center (AAA) generates a session key for that particular wireless device using a random key generator (KEY G) 220. The generated session key (first key) is then provided back to the wireless device via a reply signal 240. The authentication center 120 may further assign a time period with which the assigned session key may be maintained and used by the wireless device. Upon expiration of the assigned time period, the wireless device or the authentication center may be assigned with a new session key or be deleted from the database record 210. As a further embodiment, the assigned time period may be renewed or extended each time the wireless device perform an authorized transaction. Accordingly, the assigned time period may expire only when the wireless device has been inactive during the assigned time period.

As a result, a secured session key is stored on both the wireless device and the authentication center for the duration of the session. As described above, the step of registrating and authenticating a subscriber or user is performed within a serving mobile communications network. The database server 160 and associated access server 150 located within a wireless or wireline Internet are not communicated with during the above described registration and authentication process. Furthermore, the step of registering and assigning a secured session key is performed within the wireless device's secured mobile network. Accordingly, even though the data may be stored in a public portal or server, the authentication process and the step of assigning an encryption key (session key) is performed and controlled separately within the serving mobile network. Since the data stored securely within the database server 160 are already encrypted using a data access key only known to the authentication center 120, the session key provided to the wireless device itself does not provide any unauthorized access to the data stored within the database server 160.

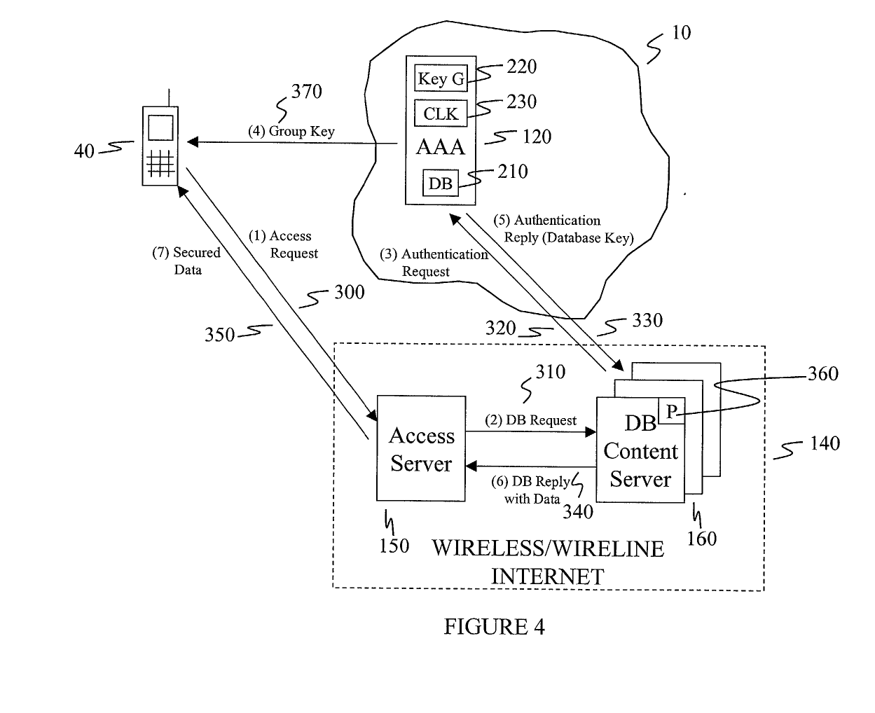

FIG. 4 is a block diagram illustrating a wireless device requesting and retrieving secured information stored within a public database server. In accordance with the teachings of the present invention, after having received the session key from the authentication center 120, the wireless device 40 transmits an access request signal 300 towards an access server 150 associated with a particular database server 160. The transmitted access request signal 300 includes the session key previously assigned by the authentication center 120 and any other separate user ID and password required by the database server 160. For illustrative purposes, a direct signal link 300 is shown between the wireless device 40 and the access server 150 in FIG. 4. However, it is to be understood that all such signals may have to be transported over a serving mobile communications network 10 and transmitted over to the wireless/wireline internet 140 as further described in FIGS. 1 and 2.

The access server 150, acting as a signal gateway for the database server 160, may verify the user identification data and any associated password provided by the wireless device 40 and determines that this particular wireless device or user has access to this particular database server. A database (DB) request signal 310 along with the session key is then forwarded over to the identified database server 160. In accordance with the teachings of the present invention, the database server 160 then forwards an authentication request 330 along with the received session key to the authentication center 120. The purpose of this request is to determine whether this particular wireless device or user has authority to access this particular database record. In response to such a request, the authentication center then references its database record 210 and determines whether this particular wireless device or user has the authority to access the identified database record. As an illustration, a company may post all of its internal and proprietary information on the database server 160. However, its employees may have different access and authority levels based on their need-to-know basis and, accordingly, assigned with different access levels to different data records.

As a result, the authentication center 120 verifies the validity of the session key and determines whether the wireless device or user associated with this particular session key is allowed to have access to that requested information. The authentication center then generates a group key from the data access key used to encrypted the requested data stored within the database server 160 and the previously assigned session key. The authentication center 120 then transmits a signal 370 to provide the requesting wireless device with the generated group key. The authentication center 120 further transmits an acknowledgement signal 320 to the database server 160 authorizing the requested data access.

The database server 160 then retrieves and provides the access server 150 with the requested data via a database reply signal 340. The access server 150 thereafter forwards the received signal to the requesting wireless device 40. In accordance with the teachings of the present invention, the data itself remains encrypted throughout the transmission to the wireless device 40. Accordingly, the database server 160 merely retrieves the encrypted data stored within its server upon receiving the authorization from the authentication server 120 and forwards the encrypted data to the requesting wireless device 40. Using the previously received session key and recently received group key, the wireless device 40 then generates or retrieves the data access key therefrom. Using the generated data access key, the wireless device 40 is able to decrypt the received data and granted access to the requested information.

As another embodiment of the present invention, after the authentication center determines that the wireless device 40 has access to that particular database record, the key generator 220 randomly generates a database key using the data access key assigned to that particular data and the session key previously assigned to the requesting wireless device. The group key is then randomly generated from the assigned session key, the database access key, and the above generated database key. The group key is transmitted to the wireless device 40 as fully described above and the database key is similarly provided back to the database server in its acknowledgement signal 320. Using the received database key, the database server further encrypts the already encrypted data stored therein. The encrypted data are then provided to the requesting wireless device 40. The wireless device 40 is then able to decrypt the received data with a temporary key generated from the previously assigned session key and group key.

By further encrypting the stored data using the database key, the data access key need not be provided to the wireless device and additional security measures are provided therefrom. Even using the same session key, in the event the wireless device attempts to access the same data within the database server, a different group key and database key will be generated by the authentication center 120. Accordingly, since the session key is never provided to the wireless device, an authorized disclosure of the group key will not allow the wireless device to have additional access to the stored data.

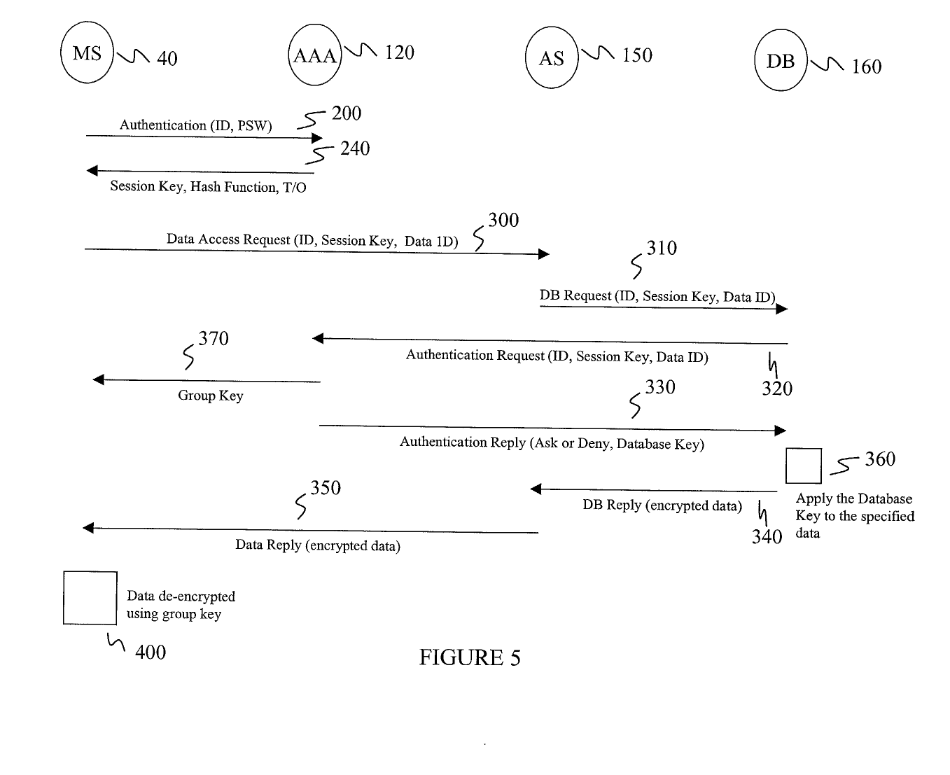

FIG. 5 is a signal sequence diagram illustrating the signals transmitted to request and to gain access to securely stored data within the database server. In accordance with the teachings of the present invention, the wireless device 40 registers and performs authentication with an associated authentication center 120 via transmitting an authentication request signal 200 thereto. The authentication request signal 200, for example, may include an user id number and associated password. The authentication center 120 validates and authenticates the subscriber and generates a session key. The generated session key along with a valid time period 240 are then communicated back to the wireless device 40. Additionally, an appropriate hash function algorithm may also be provided to the requesting wireless device 40. Alternatively, such a hash function algorithm may already be included in the wireless device 40. As an illustration, the wireless device 40 may utilize the received hash function to decrypt and/or encrypt certain data using the received session key along with any other required keys.

In response to a need to access particular data within a database server 160, the wireless device 40 transmits a data access request signal 300 to the access server 150 serving the particular database server 160. The transmitted data access request signal 300 includes the session key assigned from the authentication center 120 and data id specifying a particular database record. It may further contain appropriate user id data along with password data required by the access server 150. After verifying the relevant user id, the access server 150 forwards the received database request 310 to the database server 160. In accordance with the teachings of the present invention, the database server 160 then transmits a separate authentication request 320 querying the authentication center 120 to verify whether this particular user assigned with the received session key is allowed to access the identified database record. In response to a determination that this user has authority to access that particular data, a group key 370 is transmitted directly from the authentication center 120 to the wireless device 40. An appropriate response signal 330 is also provided to the querying database server 160. As fully described above, a database key may also be generated and provided back to the database server 160.

Using the provided database key, the database server further encrypts the stored data and provides the encrypted data to the access server 150 via a database reply signal 340. The reply signal carrying the requested data 350 is then similarly provided back to the wireless device 40. Using the group key received via a separate signal path 370 from the authentication center 120, the wireless device decrypts the received encrypted data and is granted access thereto 400.

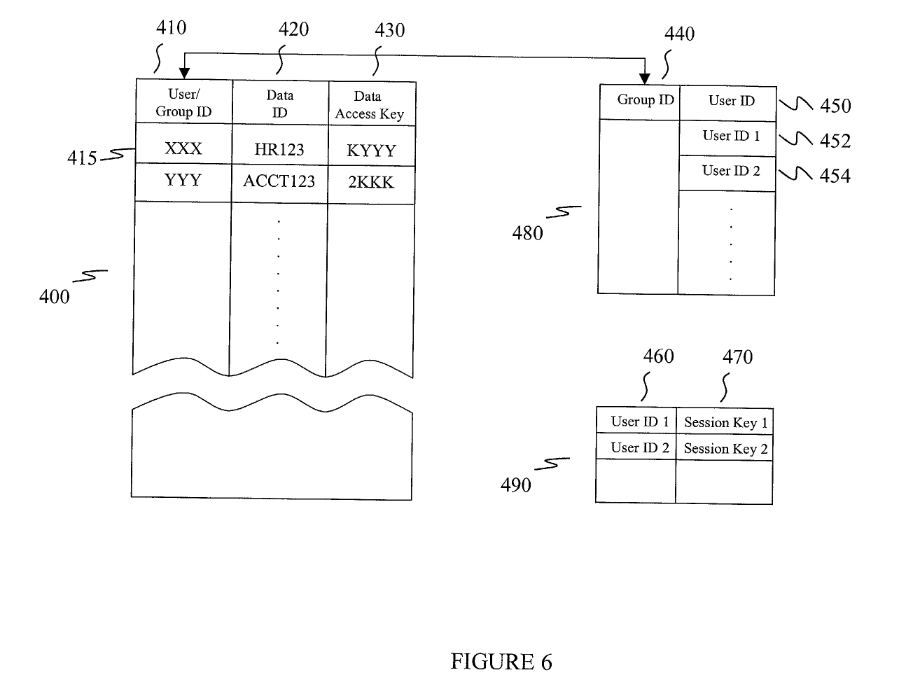

FIG. 6 is a block diagram illustrating the data structure for storing a data access key for a particular data record within the authentication center. In accordance with the teachings of the present invention, a master database access table 400 is maintained within the authentication center. As an illustration, a particular user group 410 having the authority to access a particular database record or id 420 is correlated within the master database table. A data access key 430 used to encrypt the actual data stored within the database server is further correlated and stored within the master database table. Accordingly, each record 415 within the master database table 400 specifies which user group 410 is allowed to have access to which particular data record 420 stored within an associated database server encrypted using an associated access key 430.

The authentication center may also include a user group table 480 wherein one or more users are correlated with or assigned to a particular user group. As illustrated, a particular user group 440 is assigned with User ID 450, User ID1 452 and User ID2 454, etc. As a result, in response to a request from a database server to determine whether a particular user has authority to access a particular database record, the authentication center determines with which group ID, for example, this particular user is associated by referencing the user group table 480. By referencing the master database table, the authentication center is then able to determine whether this particular user belonging to a particular group has authority to access this identified database record. Additionally, the authentication center may also include a session key table. After generating and assigning a particular session key 470 for a newly registering wireless device or user 460, the assigned session key is stored and correlated with that user id in the session key table 490. The authentication center subsequently uses this session key table 490 to verify whether a particular user attempting to access a database server identifying itself with a particular session is indeed the right user assigned with that session key value.

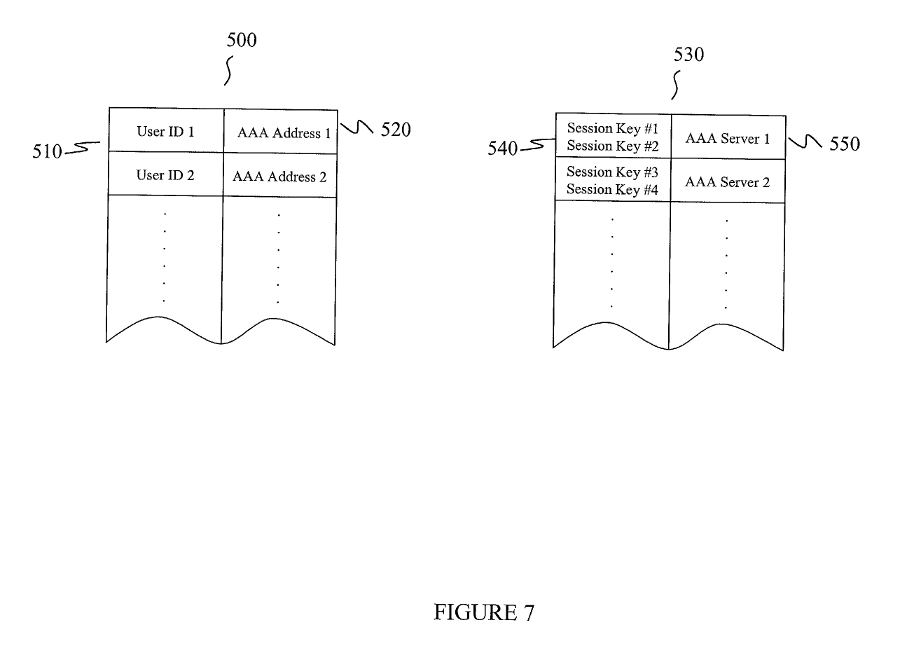

FIG. 7 is a block diagram illustrating the data structure for identifying a particular authentication center associated with a particular user or wireless device within the database server. Since different users or wireless devices may be associated with different mobile communication networks and authentication centers, an authentication center table 500 is maintained within the database server for associating a particular user 510 with a particular authentication center 520. By referencing this authentication center table 500 in response to receiving a data access request from a particular user, the database server determines with which authentication center it needs to communicate in order to receive the appropriate authorization. As another embodiment of the teachings of the present invention, session keys may further be correlated with a particular authentication server. As an illustration, the authentication center table 530 alternatively stores one or more session keys 540 by correlating them with a particular authentication center 550. In response to receiving a data request signal with a particular session key from a wireless device, the database server may reference the authentication center table 530 to determine with which authentication center it needs to communicate.

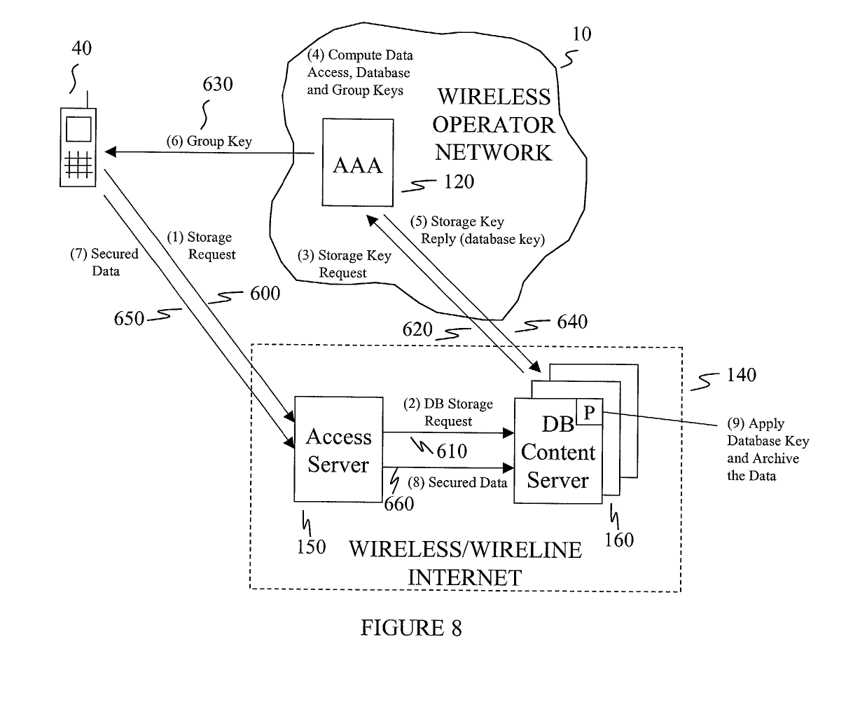

Reference is now made to FIG. 8 illustrating a block diagram of a wireless device storing data securely within the database server in accordance with the teachings of the present invention. In order for the mobile station 40 to store and update the database server 160 with certain data, it transmits a data store request signal 600 to the access server 150 associated with a particular database content server 160. The transmitted data store request signal 600 includes the session key that was previously assigned by the authentication center during user registration. The data store or update request 610 is then communicated from the access server 150 to the database server 160. The database server 160, in turn, verifies that the user has storage permission for the requested data by sending the received session key, the access rights for the requested data and a transaction identifier to the authentication center 120. When the authentication request signal 620 is received, the authentication center 120 validates the session key and the user access privileges regarding that particular data record. Upon successful verification, the authentication center determines the associated data access key for that particular data record and creates a database key using the determined data access key and the assigned session key. A group key is further generated based on the session key, the data access key, and the database key. The generated group key is then transmitted to the requesting mobile station 40 via separate signaling link 630. Similarly, the generated database key is transmitted back to the database server 160 via a replay signal 640. Accordingly, the mobile station receives the group key as an indication of approval on its request 600 to update and store data within the database server 160. The authentication center 120 may further transmit the received transaction identifier within the group key signal 630.

Using the received group key along with the previously assigned session key, the mobile station 40 encrypts the data to be stored in the database server 160. The encrypted data is then transmitted to the access server via a signaling link 650. The secured data received from the mobile station 40 is then forwarded over from the access server 150 to the database server 160 via a signal 660. The database server then applies the received database key to the received data stream from the mobile station 40 and stores the results.

Accordingly, the result of applying the database key to the secured data received from the mobile station 40 is data stored and encrypted using the data access key. However, the data access key itself is never disclosed or generated at the database server. As a result, data is securely transmitted from the mobile station 40 to the database server 160 and securely stored using an encryption key that is only known to the authentication center 120.

Although a preferred embodiment of the method and apparatus of the present invention has been illustrated in the accompanying Drawings and described in the foregoing Detailed Description, it will be understood that the invention is not limited to the embodiment disclosed, but is capable of numerous rearrangements, modifications and substitutions without departing from the spirit of the invention as set forth and defined by the following claims. Thus, although the description of this invention is made in the context of a public land mobile network (PLMN) utilizing a GSM network, it should be realized that the teachings of the present invention apply as well to any wireless communications network and associated computer and database networks.

What is claimed is:

1. A method of communicating data securely within a wireless communications network, comprising the steps of:
receiving a first authentication request from a mobile station;
providing a first key to said mobile station in response to said authentication;
receiving a second authentication request from a database server, said second authentication request further including said first key provided by said mobile station and a particular database record to which said mobile station is requesting access;
determining whether said mobile station has authority to access said particular database record; and
in response to said affirmative determination,
instructing said database server to provide information associated with said requested database record to said mobile station wherein said information is encrypted; and
providing said mobile station with a second key enabling said mobile station to decrypt said information received from said database server using said second key.

2. The method of claim 1 wherein said step of providing said first key to said mobile station further comprises the step of providing a time out period for said first key to said mobile station.

3. The method of claim 1 wherein said information stored in said database server is encrypted using a data access key and said second key is generated from said data access key and said first key.

4. The method of claim 1 wherein said step of instructing said database server to provide information to said mobile station further comprises the step of providing said database server with a third key wherein said third key is used by said database server to further encrypt said information.

5. The method of claim 4 wherein said information stored in said database server is encrypted using a data access key and wherein said third key is generated from said data access key and said first key and said second key is generated from said data access key, said first key and said third key.

6. The method of claim 1 further comprising the steps of:
receiving a third authentication request from said database server requesting authorization to update said particular database record by said mobile station;
determining whether said mobile station has authority to update said database record; and
in response to an affirmative determination,
instructing said database server to allow said mobile station to update information associated with said database record; and
providing said mobile station with said second key enabling said mobile station to encrypt any information to be transmitted over to the database server to be updated at said database record.

7. The method of claim 1 wherein said information stored in said database record is encrypted using a data access key and said second key provided to said mobile station is generated from said data access key and said first key.

8. The method of storing and communicating data securely within a mobile telecommunications network wherein said mobile telecommunications network provides wireless service to a wireless device and further includes a mobile authentication server, comprising the steps of:
storing particular information within a database server wherein said data is stored encrypted using a first encryption key;
receiving a request from said wireless device to access said information within said database server;
in response to said request, transmitting a authentication request from said database server to said mobile authentication server;
receiving authentication approval from said authentication server regarding said wireless device for said requested information; and
providing said requested information to said wireless device without decrypting said information.

9. The method of claim 8 wherein said step of receiving said authentication approval from said authentication server further comprises the steps of:
receiving a second encryption key from said authentication server;
encrypting said stored information using said second encryption key; and
providing said encrypted information to said wireless device.

10. The method of claim 8 wherein said step of receiving said request from said wireless device to access said information further comprises the step of receiving a session key generated by said authentication server from said wireless device.

11. The method of claim 10 wherein said step of transmitting said request to said authentication server further comprises the step of including said session key within said request.

12. The method of claim 8 further comprising the steps of:
receiving a second request from said wireless device to store particular information within said database server;
transmitting a second authentication request to said authentication server;
receiving second authentication approval from said authentication server instructing said database server to allow said wireless device to update said database server with said requested information;
receiving said particular information from said wireless device wherein said information being encrypted using a particular encryption key; and
storing said encrypted information within said database server.

13. An authentication server for communicating data securely within a wireless communications network providing wireless service to a wireless device and communicatable within a database server associated within a data communications network, comprising:
a session key generator for generating a particular session key to be used by said wireless device in response to said wireless device registering with said authentication server;
a database record for correlating a particular database record with a particular first encryption key;
wherein said database record further correlating identities of authorized users with said particular database record;
an encryption key generator for generating a second encryption key to be provided to said wireless device for decrypting certain information associated with said database record stored within said database server.

14. The authentication server of claim 13 further comprising a clock module for assigning a time period for said session key generated for said wireless device for said assigned time period.

15. The authentication server of claim 13 wherein said encryption key generator generates said second encryption key from said session key and said first encryption key.

16. The authentication server of claim 13 further comprises an interface module for receiving an authentication request from said database server wherein said authentication request further includes said session key associated with said wireless device and particular database record to which said mobile device requested access.

17. The authentication server of claim 16 further comprising a second encryption key generator for generating a third encryption key to be provided to said database server in response to said authentication request wherein said third encryption key used by said database server for further encrypting said information stored within said database server associated with said requested database record.

18. The authentication server of claim 17 wherein said encryption key generator generates said second encryption key from said session key, said first encryption key and said third encryption key.

19. A database server for storing and communicating data securely with a wireless device associated within a mobile communications network, said mobile communications network including a mobile authentication server, comprising:
means for storing particular information within said database server wherein said data is stored encrypted using a first encryption key;
means for receiving a request from said wireless device to access said stored information within said database server;
means for transmitting an authentication request to said mobile authentication server in response to said request;
means for receiving authentication approval from said authentication server regarding said wireless device for said requested information; and
means for providing said requested information to said wireless device without decrypting said information.

20. The database server of claim 19 wherein said means for receiving said authentication approval from said authentication server further comprises:
means for receiving a second encryption key from said authentication server;
means for encrypting said stored information using said second encryption key; and
means for providing said encrypted information to said wireless device.

21. The database server of claim 19 wherein said request from said wireless device to access said information further comprises a session key generated by said authentication server from said wireless device.

22. The database server of claim 21 wherein said request to said authentication server further comprises said session key received from said wireless device.
